(19) United States
(12) Patent Application Publication
(10) Pub. No.: US 2012/0205395 A1
(43) Pub. Date: Aug. 16, 2012

(54) Apparatus for Dispensing Food Product

(76) Inventor: Shane Robert McGill, Kent (GB)

(21) Appl. No.: 13/497,638

(22) PCT Filed: Sep. 21, 2010
(86) PCT No.: PCT/GB10/51578

§ 371 Date: Apr. 23, 2012

Related U.S. Application Data
(60) Provisional application No. 61/244,505, filed on Sep. 22, 2009.

(30) Foreign Application Priority Data
Sep. 22, 2009 (GB) 0916618.2

(51) Int. Cl. B65D 35/28; A23G 9/28; G01F 11/00; B65D 35/56

(52) U.S. Cl. 222/95; 222/386; 222/105

(57) ABSTRACT

An apparatus for dispensing ice cream includes a seating for a container and a plunger for extruding product from the container. An actuator controls movement of the plunger between retracted and extended positions. An output member of the actuator moves from an extended position to a retracted position to drive the plunger to its extended position, for a dispensing operation. The output member is arranged for upward movement to move the plunger to its retracted position. The output member and plunger have respective axes of movement which are off set from one another, one behind the other. The actuator is arranged in a housing and the plunger is located at a height generally above the actuator.

The present invention relates to apparatus for dispensing food product, in particular frozen or semi-frozen confections such as ice cream and sorbet.

A commercially successful ice cream dispensing apparatus is described and illustrated in U.S. Pat. No. 5,918,767. The apparatus includes a holder for a container of ice cream and a plunger operable to extrude ice cream from the container. Conveniently, the holder is mounted on a hinged support, so as to be movable between a loading position for inserting the container into or removing it from the holder and a dispensing position for dispensing ice cream from the container via the plunger.

The apparatus includes a dispensing mechanism for controlling movement of the plunger. In particular, the dispensing mechanism includes a linear actuator having an output member which is movable from a refracted position to an extended position in order to drive the plunger in a dispensing direction. The linear actuator is mounted directly above the plunger, thereby increasing the height of the apparatus, in particular the dispensing head.

It is an object of the invention to provide a more compact dispensing apparatus.

According to one aspect of the present invention, there is provided an apparatus for dispensing food product, in particular frozen or semi-frozen confections such as ice cream and sorbet, including a holder for receiving a container of product to be dispensed and a plunger arranged for movement between a retracted position and an extended position for extruding product from a container received in the holder, the apparatus further including an actuator for controlling movement of the plunger between the retracted and extended positions, the actuator having an output member arranged to move from an extended position to a retracted position in order to drive the plunger from its retracted position to its extended position for a dispensing operation.

Hence, the actuator is configured for operation in an opposite manner to the conventional dispensing apparatus known from U.S. Pat. No. 5,918,767, i.e. an apparatus in accordance with the invention has an actuator which retracts in order to extrude.

Arranging the actuator in this way (i.e. retracting when dispensing) allows for a more compact apparatus, particularly with regard to the height of the apparatus above the normal operating position of the holder.

The apparatus is particularly suited for use with containers having an outlet through which product can be extruded, e.g. via inward deformation or movement of part of the container in order to reduce the internal volume of the container. An example of such containers is shown in U.S. Pat. No. 5,918,767, wherein an upper part of a container is configured to deform into a lower part of the container, the lower part having an outlet through which product can be extruded upon inward deformation of the upper part. Another suitable container consists of a cylinder having an outlet at one end and a movable piston at the other end, wherein the piston is movable in the direction of the outlet for extruding product through the outlet.

The output member and plunger have respective axes of movement and in preferred embodiments these axes are off set from one another. This allows for a particularly compact apparatus. For example, in a particularly preferred embodiment, the apparatus has a front face and the axis of movement of the actuator is off set to the rear of the axis of movement of the plunger, with respect to the front face of the apparatus.

A particularly preferred compact assembly is provided using a linkage arranged for operative communication between the plunger and the output member, wherein the output member is arranged to push the linkage in order to move the plunger to its refracted position and to pull the linkage in order to drive the plunger to its extended position.

The linkage may take the form of a cantilever movable about a fixed pivot in response to movement of the output member, in which case it is preferred if a first end of the linkage is pivotably connected at a fixed pivot, a second end of the linkage is pivotably coupled to the plunger, and the output member is coupled to the linkage between said first and second ends.

In preferred embodiments, the pivotable coupling between the linkage and the plunger includes an elongate slot and pin coupling, wherein the pin is movably received in the slot and the slot moves relative to the pin during movement of the linkage.

Preferably the output member is arranged for downward movement, to drive the plunger from its retracted position to the extended position for dispensing purposes. The actuator is preferably a linear actuator wherein the output member is arranged for reciprocation along a fixed linear axis.

In preferred embodiments, the actuator has a body which is arranged for movement in the event that product within a container in the holder is too hard to be dispensed by the plunger, the apparatus including a safety switch to cut power to the actuator in the event of movement of the actuator above a predetermined threshold.

Another aspect of the invention provides a method of dispensing food product, in particular frozen or semi-frozen confections such as ice cream and sorbet, the method comprising the steps of positioning a container of product to be dispensed in a holder, and moving a plunger from a refracted position to an extended position for extruding product from an outlet in the container, the method further including the step of using an actuator to control movement of the plunger between the retracted and extended positions, wherein the actuator has an output member which is arranged for movement from an extended position to a retracted position in order to drive the plunger to its extended position.

A further aspect of the invention provides apparatus for dispensing food product, in particular frozen or semi-frozen confections such as ice cream and sorbet, the apparatus including a seating for receiving a container of product to be dispensed, and a dispensing head in which a plunger is located for movement between a retracted position and an extended position for extruding product from a container received on the seating, the apparatus further including an actuator having an output member movable for controlling movement of the plunger between the retracted and extended positions, wherein the axis of movement of the plunger between said retracted and extend positions is offset from the axis of movement the output of the actuator.

A still further aspect of the invention provides a method of dispensing food product, in particular frozen or semi-frozen confections such as ice cream and sorbet, the method comprising the steps of positioning a container of product to be dispensed in a holder, and moving a plunger from a refracted position to an extended position for extruding product from an outlet in the container, the method further including the step of using an actuator to control movement of the plunger between the retracted and extended positions, wherein the axis of movement of the plunger between said retracted and extend positions is offset from the axis of movement the output of the actuator.

A further aspect of the invention provides apparatus for dispensing food product, in particular frozen or semi-frozen confections such as ice cream and sorbet, the apparatus including a seating for receiving a container of product to be dispensed, and a dispensing head in which a plunger is located for movement between a retracted position and an extended position for extruding product from a container received on the seating, the apparatus further including an actuator having an output member movable for controlling movement of the plunger between the retracted and extended positions, wherein the apparatus defines a housing having an upright compartment in which the actuator is located and wherein the dispensing head is located at a height generally above the actuator.

A still further aspect of the invention provides a method of dispensing food product, in particular frozen or semi-frozen confections such as ice cream and sorbet, the method comprising the steps of positioning a container of product to be dispensed in a holder, and moving a plunger from a refracted position to an extended position for extruding product from an outlet in the container, the method further including the step of using an actuator to control movement of the plunger between the retracted and extended positions, wherein the apparatus defines a housing having an upright compartment in which the actuator is located and wherein the dispensing head is located at a height generally above the actuator.

Other aspects and preferred features of the invention will be apparent from the following description of preferred embodiments, made by way of example only, with reference to the accompanying drawings, in which:

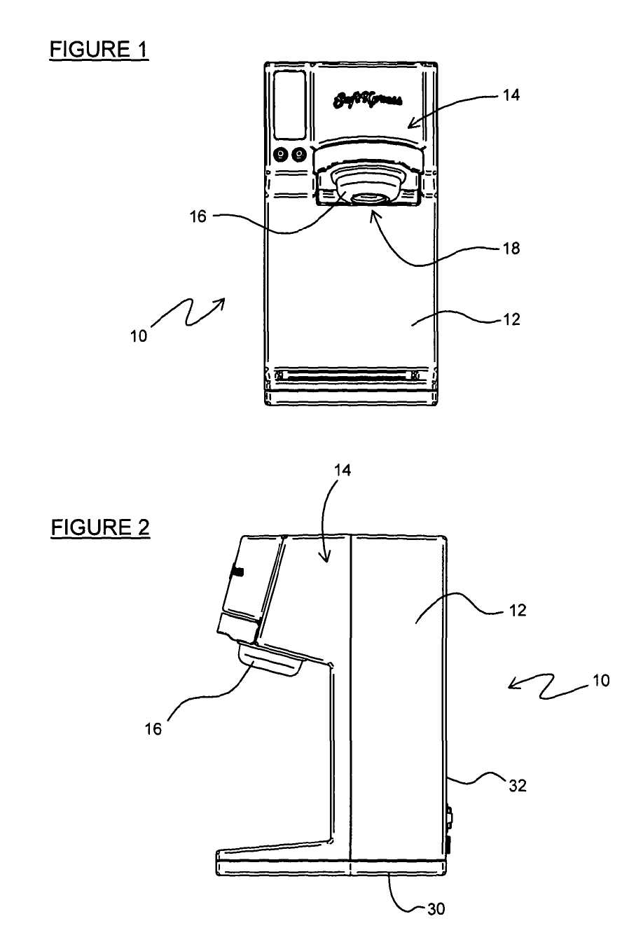

FIG. 1 is a schematic front view of a dispensing apparatus in accordance with a preferred embodiment of the invention;

FIG. 2 is a schematic side view of the dispensing apparatus of FIG. 1;

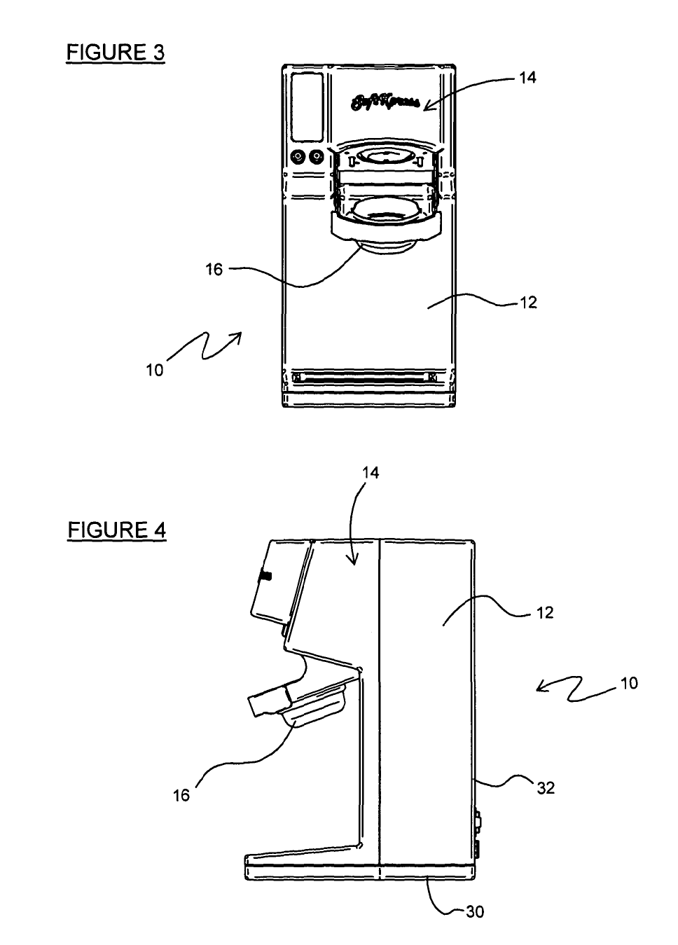

FIG. 3 is similar to FIG. 1, but shows the container holder in a loading position;

FIG. 4 is similar to FIG. 2, but shows the container holder in a loading position;

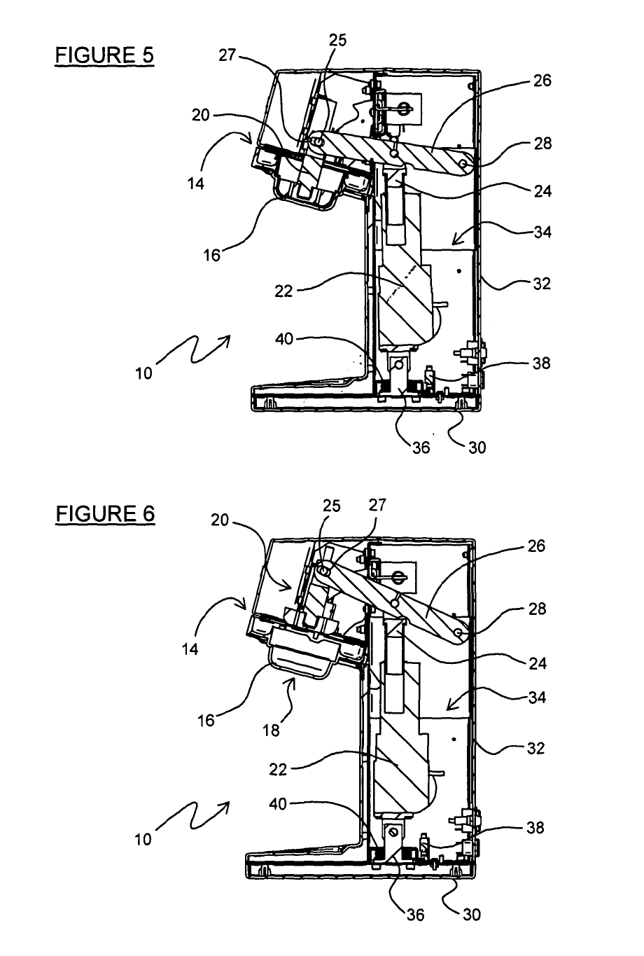

FIG. 5 is a schematic cross-section through line A-A in FIG. 1; and

FIG. 6 is similar to FIG. 5, but shows the plunger in an extended position.

An apparatus for dispensing food product, in particular frozen or semi-frozen confections such as ice cream and sorbet, is indicated generally at 10 in FIGS. 1-4.

The apparatus 10 is in the form of a housing 12 for locating at a dispensing location, the housing including a dispensing head 14 having a holder or seating 16 for supporting a container of product to be dispensed, e.g. containers of the kind described and illustrated in U.S. Pat. No. 5,918,767. Preferred containers include an outlet through which product can be extruded, e.g. via inward deformation or movement of a part of the container in order to reduce the internal volume of the container. In U.S. Pat. No. 5,918,767, an upper part of the container is configured to deform into a lower part of the container, the lower part having an outlet through which product can be extruded upon inward deformation of the upper part. Another suitable container consists of a cylinder having an outlet at one end and a movable piston at the other end, wherein the piston is movable in the direction of the outlet for extruding product through the outlet.

The holder 16 is pivotable about a horizontal axis between a dispensing position (as shown in FIGS. 1 and 2) for dispensing product from a container supported by the holder 16 and a loading position (as shown in FIGS. 3 and 4) for inserting a container into or removing it from the holder 16. Preferably, the apparatus 10 is configured so that it is not possible to remove or insert a container from the holder 16 in the dispensing position. Although not shown, a latching mechanism (e.g. a mechanical and/or electromagnetic latch) may be included for selectively securing the holder in the dispensing position.

The holder 16 includes an outlet 18 through which product can be dispensed. Preferably, the outlet 18 is positioned to correspond at least generally with the position of the container outlet.

Turning now to FIGS. 5 and 6, the dispensing head 14 includes a plunger 20 arranged for reciprocating movement along an axis between a retracted position (FIG. 5) and an extended position (FIG. 6). The axis of movement of the plunger 20 is inclined from vertical in the illustrated embodiment, allowing for easier filling of a cone or other receptacle for product dispensed from the outlet 18.

To dispense product using the apparatus 10, the holder 16 is moved to the loading position, a suitable container of product is placed in the holder 16, the holder 16 is moved to the dispensing position and the plunger 20 is then moved from the retracted position to the extended position, whereby the plunger 20 pushes against a part of the container (thereby reducing the internal volume of the container) to cause product to be extruded from the container.

The apparatus 10 includes a dispensing mechanism for controlling movement of the plunger 20 between the retracted and extended positions. The dispensing mechanism includes an actuator 22 having an output member 24 arranged for downward movement in order to drive the plunger 18 to its extended position and upward movement to return the plunger 18 to its retracted position. In this embodiment, the actuator 22 is a linear actuator and the output member 24 is arranged vertically.

The apparatus 10 includes a movable linkage or arm 26 arranged for operative communication between the plunger 20 and the output member 24 of the actuator 22. One end of the linkage 26 is pivotably connected at a fixed pivot 28 whereby the linkage 26 serves as a cantilever. The opposite end of the linkage 26 is pivotably coupled with the plunger 20 and the output member 24 of the actuator 22 is pivotably connected to the linkage 26 between its two ends.

In this embodiment, the pivotably coupling between the plunger 20 and the linkage 26 takes the form of an elongate slot and pin coupling. This is seen most clearly in FIGS. 5 and 6, wherein the pin is indicated at 25 and is associated with the plunger 20, and the elongate slot is indicated at 27 and is provided in the linkage 26. The pin 25 is movably received in the slot 27 and the slot 27 moves relative to the pin 25 during movement of the linkage 26. This allows the plunger 20 to move along the required axis of dispensing during movement of the linkage 26.

The actuator 22 is arranged to push the linkage 26 (and thereby cause the linkage 26 to pivot in an anti-clockwise direction about the fixed pivot 28, as viewed in FIG. 5) in order to move the plunger 20 to its refracted position and to pull on the linkage 26 (and thereby cause the linkage 26 to pivot in a clockwise direction about the fixed pivot 28, as viewed in FIG. 6) in order to drive the plunger 20 to its extended position.

The apparatus 10 is similar in many respects to the apparatus described in U.S. Pat. No. 5,918,767. However, the dispensing mechanism described and illustrated herein provides for a more compact assembly, thus reducing the size of the machine (in particular, the height of the dispensing head), making the apparatus more suitable for domestic use (as well as reducing material costs etc).

It can be seen that the axis of movement of the output member 24 is off set from (i.e. not coaxial with) the axis of movement of the plunger 20. More particularly, if viewed from the front face of the apparatus 10, e.g. a shown in FIG. 1, it would be understood that the axis of movement of the output member 24 is to the rear of the axis of movement of the plunger 20 with respect to the front face (clearly shown in FIG. 5).

In the illustrated embodiment, the housing 12 includes a base 30 for standing the apparatus 10 on a work surface or other horizontal surface. Alternatively, a rear wall 32 of apparatus may be located on a wall or other vertical surface.

The apparatus 10 includes an upright compartment 34 in which the actuator 22 is housed. The dispensing head 14 is arranged at one end of the upright compartment 34 and is spaced above the base 30. The apparatus 10 defines a recess 31 between the base 30 and the dispensing head 14 into which a cone or other receptacle may be positioned for a dispensing operation.

The linkage 26 extends between the dispensing head 14 and the upright compartment 34. In this particularly compact arrangement, the actuator 22 is located generally below the dispensing head 14, thereby minimising the height of the apparatus 10 above the holder 16.

The apparatus 10 includes a safety mechanism for cutting power to the actuator 22. In the event that the plunger 20 is driven against a container in the holder 16 but the product to be dispensed is too hard to be extruded, reaction forces between the plunger 20 and the actuator 22 will cause the actuator 22 to rise in the compartment 34. The lower end of the actuator 22 is associated with a trip device 36 configured to trigger a cut off switch 38 in the event of undue upward movement of the actuator 22. In this embodiment, the trip device 36 is an inverted T-shaped member connected to the lower end of the actuator 22, a part of which extends for engagement with the switch 38. The trip device 36 is biased against upward movement by springs 40, wherein the springs are selected to yield at a predetermined upward force, in order to permit controlled upward movement of the actuator 22 at a predetermined level of product hardness. In other embodiments, the apparatus may include an electronic safety cut off arrangement, e.g. for measuring resistance to movement of the plunger.

The apparatus 10 includes a control panel and associated control circuitry indicated generally at 42, for automatic operation of the plunger 20. The control panel 42 includes a dispensing button 44 which, if selected, will activate the actuator 22 for a dispensing operation. However, the control circuitry is preferably configured to prevent activation of the actuator 22 if the holder 16 is not in the dispensing position.

The holder 16 is preferably locked against movement from the dispensing position by a latching mechanism (not shown) during movement of the plunger 20 and is preferably released from the dispensing position (e.g. so as to fall under gravity to the loading position) automatically after movement of the plunger 20 in the dispensing direction, so that the used container may be removed. Hence, a used container will be visible in the holder after dispensing, thereby reducing the likelihood of a used container being stored in the holder for an undesired time period.

The control circuitry is preferably configured to automatically retract the plunger after a dispensing operation.

The control panel 42 includes a manual release button 46 for releasing the holder 16 from the dispensing position. However, this is preferably operable only when the plunger is inactive and/or active in a return direction.

The control circuitry is preferably configured to activate a visual and/or audible alarm in the event that the cut off switch 38 is triggered. Preferably, the control circuitry is also configured to retract the plunger 20 after activation of the switch 38. The control circuitry may also be configured to allow the holder 16 to be moved to the loading position only after the plunger 20 has been fully retracted.

The control circuitry is preferably configured to operate a cleaning mode, wherein the plunger 20 can be moved to a fully extended position when the holder 16 is in the loading position. This mode is activated if both buttons 44, 46 are depressed for a set time period (e.g. 5 seconds) and the holder 16 is in the loading position.

The control circuitry may be configured so that a user can manually determine the volume of product to be dispensed, e.g. the actuator 22 may be operable only when pressure is applied to the dispensing button 44 or between a first activation of the button 44 (to start the actuator 22) and a second activation of the button 44 (to stop the actuator 22).

1. Apparatus for dispensing food product, in particular frozen or semi-frozen confections such as ice cream and sorbet, the apparatus including a seating for receiving a container of product to be dispensed and a plunger arranged for movement between a retracted position and an extended position for extruding product from a container received on the seating, the apparatus further including an actuator for controlling movement of the plunger between the retracted and extended positions, the actuator having an output member arranged for movement from an extended position to a retracted position in order to drive the plunger to its extended position for a dispensing operation.

2. Apparatus according to claim 1 wherein the output member is arranged for upward movement to move the plunger to its retracted position.

3. Apparatus according to claim 1 further including a linkage arranged for operative communication between the plunger and the output member, wherein the output member is arranged to push the linkage in order to move the plunger to its retracted position and to pull the linkage in order to drive the plunger to its extended position.

4. Apparatus according to claim 3 wherein the linkage is a cantilever movable about a fixed pivot in response to movement of the output member.

5. Apparatus according to claim 3 wherein a first end of the linkage is pivotably coupled to the plunger, a second end of the linkage is pivotably connected at a fixed pivot, and the output member is coupled to the linkage between said first and second ends.

6. Apparatus according to claim 1 wherein the output member and plunger have respective axes of movement which are off set from one another.

7. Apparatus according to claim 6 wherein the apparatus has a front face and wherein the axis of movement of the actuator is to the rear of the axis of movement of the plunger with respect to the front face.

8. Apparatus according to claim 1, wherein the apparatus defines a housing having an upright compartment in which the actuator is located and wherein the plunger is mounted in a dispensing head on said compartment, wherein the dispensing head is located at a height generally above the actuator.

9. Apparatus according to claim 1, wherein the actuator has a body which is arranged for movement in the event that product within a container in the holder is too hard to be dispensed by the plunger, the apparatus including a safety switch to cut power to the actuator in the event of movement of the actuator above a predetermined threshold.

10. Apparatus according to claim 9 wherein the lower end of the actuator is associated with a trip device configured to trigger a cut off switch in the event of undue upward movement of the actuator.

11. (canceled)

12. Apparatus for dispensing food product, in particular frozen or semi-frozen confections such as ice cream and sorbet, the apparatus including a seating for receiving a container of product to be dispensed, and a dispensing head in which a plunger is located for movement between a retracted position and an extended position for extruding product from a container received on the seating, the apparatus further including an actuator having an output member movable for controlling movement of the plunger between the retracted and extended positions, wherein the axis of movement of the plunger between said retracted and extended positions is offset from the axis of movement of the output of the actuator.

13. Apparatus according to claim 12 wherein the apparatus has a front face and wherein the axis of movement of the actuator is to the rear of the axis of movement of the plunger with respect to the front face.

14. Apparatus according to claim 12 wherein the output member is arranged for upward movement to move the plunger to its retracted position.

15. Apparatus according to claim 12, further including a linkage arranged for operative communication between the plunger and the output member, wherein the output member is arranged to push the linkage in order to move the plunger to its refracted position and to pull the linkage in order to drive the plunger to its extended position.

16-17. (canceled)

18. Apparatus according to claim 12 wherein the apparatus defines a housing having an upright compartment in which the actuator is located and wherein the dispensing head is located at a height generally above the actuator.

19. Apparatus according to claim 12 wherein the actuator has a body which is arranged for movement in the event that product within a container in the holder is too hard to be dispensed by the plunger, the apparatus including a safety switch to cut power to the actuator in the event of movement of the actuator above a predetermined threshold.

20. Apparatus according to claim 20 wherein the lower end of the actuator is associated with a trip device configured to trigger a cut off switch in the event of undue upward movement of the actuator.

21. Apparatus for dispensing food product, in particular frozen or semi-frozen confections such as ice cream and sorbet, the apparatus including a seating for receiving a container of product to be dispensed, and a dispensing head in which a plunger is located for movement between a retracted position and an extended position for extruding product from a container received on the seating, the apparatus further including an actuator having an output member movable for controlling movement of the plunger between the retracted and extended positions, wherein the apparatus defines a housing having an upright compartment in which the actuator is located and wherein the dispensing head is located at a height generally above the actuator.

22. Apparatus according to claim 21 wherein the axis of movement of the plunger between said retracted and extend positions is offset from the axis of movement of the output of the actuator.

23. Apparatus according to claim 22 wherein the apparatus has a front face and wherein the axis of movement of the actuator is to the rear of the axis of movement of the plunger with respect to the front face.

24. Apparatus according to claim 22 wherein the output member is arranged for upward movement to move the plunger to its retracted position.

25. Apparatus according to claim 22 further including a linkage arranged for operative communication between the plunger and the output member, wherein the output member is arranged to push the linkage in order to move the plunger to its retracted position and to pull the linkage in order to drive the plunger to its extended position.

26-27. (canceled)

28. Apparatus according to claim 21 wherein the actuator has a body which is arranged for movement in the event that product within a container in the holder is too hard to be dispensed by the plunger, the apparatus including a safety switch to cut power to the actuator in the event of movement of the actuator above a predetermined threshold.

29. Apparatus according to claim 28 wherein the lower end of the actuator is associated with a trip device configured to trigger a cut off switch in the event of undue upward movement of the actuator.

30. Apparatus according to claim 1, wherein the actuator is mounted in a housing and is arranged below the plunger.
